(19) United States
(12) Patent Application Publication
(10) Pub. No.: US 2006/0154822 A1
(43) Pub. Date: Jul. 13, 2006

(54) Compositions and methods to improve the storage quality of packaged plants

(75) Inventors: Peter M.A. Toivonen, Summerland (CA); Changwen Lu, Penticton (CA)

Correspondence Address: BERESKIN AND PARR, 40 KING STREET WEST, BOX 401, TORONTO, ON, M5H 3Y2, CA

(73) Assignee: Her Majesty in Right of Canada as Represented by the Minister of Agriculture and Agri-Food Canada, Ottawa (CA)

(21) Appl. No.: 11/328,060

(22) Filed: Jan. 10, 2006

Related U.S. Application Data
(60) Provisional application No. 60/642,103, filed on Jan. 10, 2005.

(51) Int. Cl. A01N 63/00; A01N 43/16

(52) U.S. Cl. 504/117; 504/292

(57) ABSTRACT

The present invention relates to a composition comprising a cyclopropene, for example 1-MCP, encapsulated in a cyclodextrin matrix, a hygroscopic compound, yeast and/or other enzymes involved in the production of alcohols and aldehydes from organic substrates, and, optionally an organic substrate for the enzymes. The composition of the present invention provides, under controlled conditions, the co-release of the cyclopropene, alcohols, aldehydes and carbon dioxide, which work together to improve the quality of plants during storage. Methods and commercial packages employing these compositions are also disclosed.

### FIELD OF THE INVENTION

The present invention relates to improved compositions and methods which function to maintain the quality of packaged plants, in particular fruits and vegetables; during storage. Specifically the present invention relates to compositions and methods to effect the co-release of cyclopropenes, alcohols, aldehydes and carbon dioxide in a modified atmosphere environment to maintain the quality of plants packaged therein.

### BACKGROUND OF THE INVENTION

1-Methylcyclopropene (1-MCP) is a recently discovered ripening inhibitor (Sisler, E. C., Blankenship, S. M. (1996) Method of counteracting an ethylene response in plants, U.S. Pat. No. 5,518,988; Blankenship, S. M. and J. M. Dole (2003) 1-Methylcyclopropene: a review, Postharvest Biology and Technology 28: 1-25) that is believed to have a high commercial potential for improving the quality retention during storage of perishable fruit and vegetable products (Watkins, C. B., Nock, J. F. and Whitaker B. D. (2000) Reponses of early, mid and late season apple cultivars to postharvest application of 1-methylcyclopropene (1-MCP) under air and controlled atmosphere storage conditions, Postharvest Biology and Technology 19: 17-32; Jeong, J., Huber, D. J. and Sargent, S. A. (2003) Delay of avocado (Persea americana) fruit ripening by 1-methylcyclopropene and wax treatments Postharvest Biology and Technology 28: 247-257). 1-MCP achieves this by blocking the binding site of ethylene in the tissue (Sisler, E. C. ibid; Blankenship, S. M. ibid). 1-MCP is a very labile gas which decomposes rapidly and hence has been immobilized or trapped within cyclodextrin molecules to produce a commercially stable source of the gas. Application of water or buffer solution is currently used commercially to initiate release of the 1-MCP from its cyclodextrin matrix. This system of release is efficient for the handling of products such as winter storage apples in large volume cold rooms, however, there are uses for 1-MCP in different postharvest situations where products are generally handled in smaller volumes. Examples of the latter include stone fruits (peaches, cherries, nectarines, apricots, and plums) and fresh-cut packaged fruit and vegetable products (salad mixes). Methods to release 1-MCP from the cyclodextrin matrix have been reported (Sittipod, S., Hart, B. and Beaudry, R. (April, 2003) Modulating the release of 1-methylcyclopropene from cyclodextrin, On-site program for the Science Symposium of the Annual Meeting of the International Fresh-Cut Produce Association, p. 4), including the mixing of hygroscopic salts with the immobilized 1-MCP powder wherein release is effected once the salt liquefies upon absorption of humidity which surrounds the packaged fruit or vegetable product. Improvements in the response to 1-MCP (in terms of controlling softening) have been demonstrated when apples are held under controlled atmospheres, are co-treated under high CO₂ atmospheres or treated with other growth regulatory chemicals in addition to 1-MCP (Watkins, C. B. ibid; Lu, C. and Toivonen, P. M. A. (2003). 1-Methylcyclopropene plus high CO₂ applied after storage reduces ethylene production and enhances shelf life of Gala apples, Canadian Journal of Plant Science 83: 817-824; Rupasinghe, H. P. V., Murr, D. P., DeEll, J. R., and Porteous, M. D. (2000) Synergistic effect of AVG, 1-MCP and CA on softening of apples, HortScience 35: 411). All of these prior treatments have been done at low storage temperatures, however, stone fruits and fresh-cut fruits and vegetables are often handled at elevated or moderate storage temperatures. In such situations, it has been observed that I -MCP treatment alone cannot overcome the propensity for the product to decay.

If 1-MCP is continuously released, a better, more uniform response in terms of quality retention is achieved (Sittipod, S. ibid; Canoles, M. A. and Beaudry, R. (2002) Effects of single and continuous application of 1-methylcyclopropene on ripening of tomato, On-site program of the 26^{th} International Horticultural Congress, p. 271). Multiple applications of 1-MCP have been shown to significantly improve postharvest quality maintenance of apples (Mattheis, J. and Fan, X. (2000) Multiple applications extend duration of 1-methylcyclopropene-induced responses of apple and pear fruit, HortScience, 35:408), pears (Mattheis, J. et al.) , tomatoes (Canoles, M.A. and Beaudry, R. (2001) Effect of single and continuous application of 1-methycyclopropene on ripening of tomato, HortScience, 36: 467), avocados (Blankenship, S. M. ibid) and others (Blankenship, S. M. ibid), when compared with a single treatment. The reason for this is that the efficacy of 1-MCP to inhibit ethylene action and ripening is transient. Moreover, the frequency of re-application is dependent on the particular product and the storage temperature (Blankenship, S. M. ibid; Mattheis, J. ibid; Wang, C. Y. (ed.) (1990) Chilling Injury in Horticultural Crops. CRC Press, Boca Raton, Fla. 313 pp).

In summary, the current state of the art for 1-MCP application has been developed primarily to treat products at low temperature storage and in large volumes. There have been some studies on the use of co-treatments with 1-MCP, but again, these co-treatments are focused on use in large volume, winter-apple storage systems. While there have been numerous reports looking at the efficacy of 1-MCP on quality preservation of other crops which are handled in lower volumes, commercial technologies or regulatory approval for these crops has not been pursued at this time. Therefore, there exists a need to improve the technology for the release of cyclopropenes from encapsulating matrixes, for example, for use in situations where large storage room treatments or lower temperatures are not practical.

### SUMMARY OF THE INVENTION

Compositions comprising matrix-encapsulated cyclopropenes have been prepared which have improved shelf stability, improved efficiency of release of the cyclopropene, prolonged release of the cyclopropene and improved food quality preservation characteristics. The compositions comprise the cyclopropene encapsulated in a cyclodextrin-based encapsulation matrix, a hygroscopic compound and yeast and/or other enzymes involved in the production of alcohols and aldehydes from organic substrates. The compositions may further comprise an organic substrate, for example a carbohydrate, which is acted upon by yeast and/or the enzymes to produce alcohols and aldehydes. Such compositions were applied in modified atmosphere packages containing sweet cherries, peaches, nectarines, apricots, tomatoes, lettuce, onions, carrots, cabbage, broccoli and cauliflower. The sweet cherries were shown to maintain fresh-like quality after three weeks of storage at 1° C., while the peaches, nectarines and apricots maintained fresh picked quality after three to four weeks of storage at 15-20° C. Similar to the cherries, the tomatoes were shown to maintain fresh-like quality after three weeks of storage at 1° C. and 5° C. When applying the compositions in modified atmosphere packages containing various vegetables, such as salad mixes, fresh-like quality was also maintained. For a tossed salad mix which included cut iceberg lettuce, sliced red onions, whole grape tomatoes, shredded carrots and sliced red cabbage, fresh-like quality was maintained after four weeks at 5° C. when the compositions of the present invention were applied in the modified atmosphere packages containing the salad mix. For a vegetable mixture which included broccoli, cauliflower, sliced red onions and sliced carrots, fresh-like quality was maintained after four weeks at 5° C. when the compositions of the present invention were applied in the modified atmosphere packages containing the vegetable mixture.

Accordingly, the present invention relates to a composition comprising:

(a) one or more cyclopropenes of the formula I: 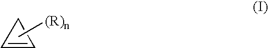
wherein
n is a number from 1 to 4,
R is selected from the group consisting of hydrogen, saturated or unsaturated C₁ to C₄ alkyl, hydroxy, halogen, saturated or unsaturated C₁ to C₄ alkoxy and amino,
n and R are selected to provide a volatile compound of formula I,
and the compound of formula I is encapsulated in a cyclodextrin-based encapsulating agent;

(b) one or more hygroscopic compounds; and

(c) yeast and/or one or more enzymes involved in the production of alcohols and aldehydes from organic substrates.

In an embodiment of the invention, the compositions further comprise one or more organic substrates which are acted upon by the yeast and/or the one or more enzymes, to produce alcohols and aldehydes.

The compositions of the invention may be formulated or packaged in any suitable form for delivery or release of the cyclopropene, alcohols, aldehdyes and/or carbon dioxide to a plant. In such formulations, the compositions may also comprise one or more adjuvants. Accordingly, the present invention also relates to a delivery vehicle comprising a composition of the present invention, and optionally, one or more adjuvants. Examples of such delivery vehicles include, but are not limited to, sachets, tablets and absorbent pads, the latter of which are also useful for protecting the plants or plant parts from injuries as well as to absorb free water from the plant or plant parts.

The compositions or delivery vehicles of the invention may be placed into a modified atmosphere package containing one or more plants or plant parts. The hygroscopic compound(s) absorbs water from the humidity vapor in the package and this hydrates the yeast mixtures and enzymes, which in turn, metabolize the cyclodextrin-based encapsulation matrix that immobilizes the cyclopropenes, as well as any organic substrates in the mixture. Metabolism of the cyclodextrin leads to release of the highly volatile cyclopropenes into the headspace of the package. Action of the yeasts and enzymes on the cyclodextrin and other organic substrates yields alcohols and aldehydes, which are also volatile and diffuse, along with the cyclopropenes, throughout the modified atmosphere package. Both the anti-ethylene effects of cyclopropenes and the bioactive effects of the alcohols and aldehydes lead to improved quality retention of the plant or plant parts and reduction of growth and survival of decay microorganisms during the storage of that package. In addition, the production of alcohol is accompanied by carbon dioxide evolution, which enhances the carbon dioxide levels in the package. High carbon dioxide levels are known to reduce rates of deterioration in plants and to inhibit the growth of many decay microorganisms. Levels of 10-15% carbon dioxide at elevated temperatures have been shown to have a similar effect to storing the product at 1° C. (Summer, N. F. (1992) Principles of disease suppression by handling practices, In: Postharvest Technology of Horticultural Crops, A. A. Kader (ed). University of California, Division of Agriculture and Natural Resources Publication 331 1, pages 109-116).

The present invention also includes a commercial package comprising a composition of the present invention, or one or more delivery vehicles comprising a composition of the present invention, enclosed in a modified atmosphere package.

The present invention further relates to a method of inhibiting an ethylene response in a plant comprising effecting the release of cyclopropene, alcohols, aldehydes and/or carbon dioxide from the compositions of the invention in the presence of the plant.

In an embodiment of the present invention, the methods are applied in modified atmosphere packaged fruits and vegetables and fresh-cut fruit and vegetable products.

The compositions and methods of the present invention represent a combined technology which acts to slow ripening, inhibit postharvest decay, slow softening and inhibit discolouring in products stored at low and elevated temperatures. In addition, products which suffer from chilling injury will benefit from being successfully stored at elevated, non-chilling temperatures. This will provide a tremendous improvement in flavour to the consumer since low temperatures are known to inhibit flavour generation in many fruits and vegetables (Wang, C. Y. ibid).

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will now be described in relation to the drawings in which:

FIG. 1 is a graph showing the shelf stability of calcium chloride based/cyclodextrin-immobilized 1-MCP release mixture in comparison to the yeast-based/cyclodextrin-immobilized 1-MCP release mixture.

FIG. 2 is a bar graph showing the initial release of 1-MCP and residual release over two subsequent days of the various release mixtures.

FIG. 3 is a bar graph showing the initial ethanol release and release over two subsequent days of the various release mixtures.

FIG. 4 is a bar graph showing the initial acetaldehyde release and release over two subsequent days of the various release mixtures.

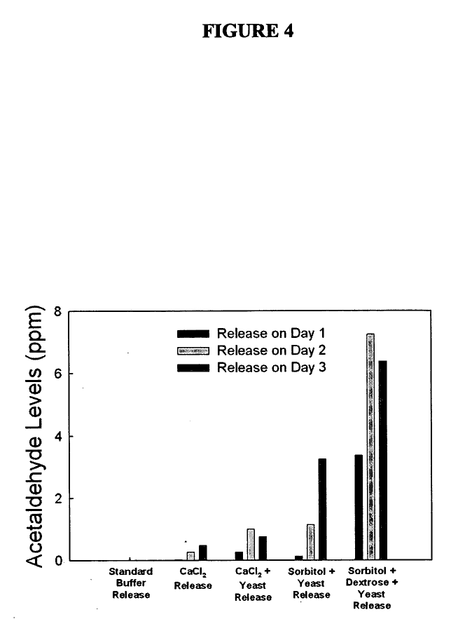

FIG. 5 is a photograph showing the quality of ‘Lapins’ sweet cherries after 3 weeks of storage in modified atmosphere packages at 1° C. with and without the co-release compositions of the present invention. Note that the fruits on the left, which were treated with the co-release compositions and having measured concentrations of 1 ppm MCP plus 10 ppm acetaldehyde, retain fresh-picked quality, while those on the right, which are the non-treated controls held under high carbon dioxide alone, show significant signs of deterioration (stem browning and fruit darkening).

FIG. 6 is a photograph showing the quality retention of ‘Hargrand’ apricots after one month of storage in modified atmosphere packages at 15° C. incorporating the co-release compositions of the present invention. Note that the fruits which were treated using the co-release compositions of the present invention (see left side of the photo), retain a fresh-picked quality after one month at elevated temperature storage, while those treated only with ethanol and acetaldehyde are very deteriorated (see right side of photo) and are beginning to liquefy.

FIG. 7 is a bar graph showing the decay or tissue leakage of sliced tomatoes after 24 days of storage in sealed trays at 1° C. and 5° C. with (NT) or without (control) the co-release compositions of the present invention.

FIG. 8 is a photograph showing the sealed trays containing the sliced tomatoes after 24 days of storage with (NT, right side of photograph) or without (CK, left side of photograph) the co-release compositions of the present invention. Note that the sealed tray of the sliced tomatoes without the co-release composition of the present invention on the left showed bloating at 24 days, whereas the sealed tray of sliced tomatoes with the co-release composition of the present invention on the right retained the dimension and form as at the original time of packaging.

FIG. 9 is a photograph showing the open trays containing the sliced tomatoes after 24 days of storage with (NT, left side of photograph) or without (CK, right side of photograph) the co-release compositions of the present invention. Note that the open tray of sliced tomatoes without the co-release composition of the present invention on the right showed deterioration of the tomato slices and extensive tissue leakage at the bottom of the tray, whereas the open tray of sliced tomatoes with the co-release composition of the present invention on the left showed that the sliced tomatoes maintain good texture and structure with only a small volume of leakage at the bottom of the tray.

FIG. 10 is a photograph showing the sealed packages of tossed salad, which include cut iceberg lettuce, sliced red onions, whole grape tomatoes, shredded carrots and sliced red cabbage, after 28 days of storage at 5° C. with (NT, right side of photograph) or without (CK, left side of photograph) the co-release compositions of the present invention. Note that the sealed package of tossed salad without the co-release composition of the present invention on the left showed discoloration and general breakdown of the vegetables, whereas the sealed package of tossed salad with the co-release composition of the present invention on the right showed that the vegetables maintained their original bright coloration and there were no indications of tissue breakdown in any of the vegetables.

FIG. 11 is a photograph showing the sealed packages of vegetable medley, which include broccoli, cauliflower, sliced red onions and sliced carrots, after 28 days of storage at 5° C. with (NT, right side of photograph) or without (CK, left side of photograph) the co-release compositions of the present invention. Note that the sealed package of vegetable medley without the co-release composition of the present invention on the left showed softening of the vegetables, whereas the sealed package of vegetable medley with the co-release composition of the present invention on the right showed that the vegetables maintained their firmness and original bright coloration.

### DETAILED DESCRIPTION OF THE INVENTION

A co-release technology for the release of effective amounts of 1-methylcyclopropene (1-MCP) in the presence of plant and plant parts has been developed. The technology involves the application of a mixture comprising sorbitol (or some other hygroscopic compound), a yeast mixture and/or enzymes involved in alcohol metabolism, cyclodextrin-immobilized 1-MCP and, optionally, dextrose (or some other carbohydrate). This mixture may be applied in a modified atmosphere system which is designed to produce carbon dioxide levels of about 5% to about 15%. This co-release technology resulted in the accumulation of 1-MCP, alcohol (ethanol or a higher alcohol), and aldehyde (acetaldehyde or a higher aldehyde) within the 5%-15% CO₂ modified atmosphere package. The use of the co-release composition in combination with the modified atmosphere package results in significant retention of plant quality at normal and elevated storage temperatures. This will permit flexibility for handling products at various temperatures and particularly, will be useful for many fruits such as stone fruits, which are chilling sensitive at normal storage temperatures (Wang. C. Y. ibid).

Accordingly, the present invention relates to a composition comprising:

(a) one or more cyclopropenes of the formula I: 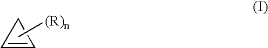
wherein
n is a number from 1 to 4,
R is selected from the group consisting of hydrogen, saturated or unsaturated C₁ to C₄ alkyl, hydroxy, halogen, saturated or unsaturated C₁ to C₄ alkoxy and amino,
n and R are selected to provide a volatile compound of formula I,
and the compound of formula I is encapsulated in a cyclodextrin-based encapsulating agent;

(b) one or more hygroscopic compounds; and

(c) yeast and/or one or more enzymes involved in the production of alcohols and aldehydes from organic substrates.

In an embodiment of the invention, the compositions further comprise one or more organic substrates which are acted upon by the yeast and/or the one or more enzymes, to produce alcohols and aldehydes.

The one or more cyclopropenes may be those in which n is a number from 1 to 4. In an embodiment of the invention, n is 1 or 2. In a further embodiment of the invention, n is 1. The cyclopropenes further include those in which R is selected from the group consisting of hydrogen, saturated or unsaturated C₁ to C₄ alkyl, hydroxy, halogen, saturated or unsaturated C₁ to C₄ alkoxy and amino. In an embodiment of the invention, R is saturated or unsaturated C₁ to C₄ alkyl, for example, methyl, ethyl, n-propyl, isopropyl, t-butyl, isobutyl, n-butyl, vinyl, 2-propenyl, and 3-butylenyl and the like. In a further embodiment of the invention, R is a straight-chain, saturated C₁ to C₄ alkyl. In a still further embodiment of the invention, R is methyl. In an embodiment of the invention, the R group on the cyclopropene is attached at the 1 position of the cyclopropene ring to provide a compound of the formula I(a):

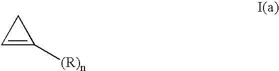

It is to be understood that R and n are selected such that a volatile cyclopropene compound is provided. By “volatile” it is meant that, at the temperature that the plant is to be stored, the compound of formula I will exist in sufficient amounts of vapour form to inhibit ripening of the plant. To “inhibit” or “suppress” or “reduce” a function or activity, such as ripening, is to reduce the function or activity when compared to otherwise same conditions except for a condition or parameter of interest, or alternatively, as compared to another conditions.

It is an embodiment of the invention that the cyclopropene is 1-methylcyclopropene (1-MCP).

The term “saturated or unsaturated C₁ to C₄ alkyl” and “saturated or unsaturated C₁ to C₄ alkoxy” as used herein refers to straight or branched chain alkyl or alkoxy radicals containing from 1 to 4 carbon atoms and, optionally, one or two, suitably one, double bond.

The encapsulating agent for the one or more cyclopropenes is a cyclodextrin, for example, α-cyclodextrin, β-cyclodextrin or γ-cyclodextrin. As would be known to one of skill in the art, any cyclodextrin or mixture of cyclodextrins, cyclodextrin polymers and modified cyclodextrins can be used. In an embodiment of the invention, the encapsulating agent is α-cyclodextrin.

The preparation of substituted cyclopropenes is known in the art. See for example, U.S. Pat. No. 5,518,988 and U.S. patent application publication no. 2002/0035146. The encapsulation of cyclopropenes into a molecular encapsulation agent complex is also known in the art. See for example U.S. Pat. No. 6,017,849.

α-Cyclodextrin-immobilzed 1-MCP is also available commercially from AgroFresh, Inc., Spring House, Pa.

The one or more hygroscopic compounds may be any Generally Regarded As Safe (GRAS) hygroscopic or water-absorbing compound, including, but not limited to, super absorbent polymers, such as sodium polyacrylate (crosslinked), acrylamide/acrylate copolymers and carboxymethylcellulose, inorganic deliquescent compounds such as calcium chloride, magnesium chloride, lithium chloride, zinc chloride, magnesium nitrate and aluminum nitrate, and hygroscopic organic compounds such as sorbitol, and any combinations and mixtures thereof. In an embodiment of the invention, the hygroscopic compound is sorbitol.

The yeast used in the compositions of the present invention is typically a dried yeast mixture. Such mixtures are available for example from L'ALLEMAND, Inc., 151 Skyway Avenue, Rexdale, Ontario M9W 4Z5. The one or more enzymes involved in the production of alcohols and aldehydes from organic substrates that may be used in the compositions of the present invention would be well known to those skilled in the art and include, but are not limited to, amylose, cellulase, phytase, hemi-cellulase, maltase, invertase, beta-glucanase and/or apha-glucosidase.

The one or more organic substrates which are acted upon by the yeast and/or the one or more enzymes, to produce alcohols and aldehydes, may include, but are not limited to, carbohydrates such as monosaccharides including, but not limited to, allose, altrose, glucose, mannose, gulose, idose, galactose, talose, ribose, arabinose, xylose, lyxose, threose, erythrose, glyceraldehydes, sorbose, fructose, dextrose, levulose and sorbitol, and disaccahrides, for example, but not limited to, sucrose, maltose, cellobiose and lactose, and combinations and mixtures thereof. When acted on by the enzymes, the one or more organic substrates are those that produce, for example, ethanol and/or acetadehyde as well as higher alcohols and/or aldehdyes, for example hexanol and hexanal. Higher alcohols and aldehydes have been shown to be inhibitory to the growth of decay organisms, while being less bioactive with regard to plant tissues. In an embodiment of the invention, the organic substrate is sorbitol.

It may also be desirable to include in the composition one or more adjuvants such as extenders, binders, lubricants, surfactants, wetting agents, spreading agents, dispersing agents, stickers, adhesives, defoamers, thickeners, emulsifying agents and the like. Such adjuvants commonly used in the art can be found in McCutcheon, John W. Inc. Detergents and Emulsifiers, Annual, Allured Publishing Company, Ridgewood, N. J., USA.

In embodiments of the invention, the percentages (expressed in terms of percent by weight of the final composition) of the components in the compositions of the present invention may be as follows:

(a) one or more cyclopropenes of the formula I—about 1% to about 25%, suitably, about 2 to about 20%;

(b) one of more hygroscopic compounds—about 40% to about 80%, suitably about 50% to about 75%; (c) yeast and/or one or more enzymes involved in the production of alcohols and aldehydes from organic substrates—about 5% to about 25%, suitably about 10% to about 20%;

(d) one or more organic substrates which are acted upon by yeast and/or the one or more enzymes to produce alcohols and aldehydes—about 0% to about 35%, suitably about 5% to about 30%; and

(e) one or more adjuvants—about 0% to about 15%, suitably about 5% to about 10%.

The term “about” as used throughout the present application means within experimental error.

Unless otherwise indicated, all percentages used throughout the present application are a percent by weight of the final composition.

In an embodiment of the invention, there is provided a composition comprising:
a) about 2% to about 20% 1-MCP encapsulated in cyclodextrin;
b) about 10% to about 20% dried yeast;
c) about 50% to about 75% sorbitol;
d) about 5% to about 30% dextrose; and optionally
e) about 0% to about 10% one or more adjuvants.

The compositions of the invention may be formulated or packaged in any suitable form for delivery or release of the cyclopropene, alcohols, aldehdyes and/or carbon dioxide to a plant. In such formulations, the compositions may also comprise one or more adjuvants. Accordingly the present invention also relates to a delivery vehicle comprising a composition of the present invention and optionally, one or more adjuvants. Examples of such delivery vehicles include, but are not limited to, sachets, tablets and absorbent pads. Other forms of delivery vehicles, as recognized in the art, are of course also possible and even desirable depending on the specific applications of the composition of the present invention. A sachet may be made of any suitable material, for example water-resistant, yet breathable material, such as spun bonded polyethylene. A typical sachet would resemble a tea bag in shape and construction and would be stored in a water impermeable container prior to use. The delivery vehicle is such that it provides a ready-to-use product, the contents of which can be designed to deliver an effective amount of active ingredients for any specific package volume or various package volumes. Alternatively, multiple delivery vehicle units designed for a smaller package may be combined and used as package size increases. The number of delivery vehicle units required would be proportional to the volume increase in the package size. The absorbent pads, in addition to being able to deliver an effective amount of active ingredients into the package, are also useful for protecting the plants or plant parts in the package from injuries as well as to absorb free water from the plant or plant parts.

The terms “plant” and “plant parts” as used throughout the present application include whole plants and any portions thereof and extend to all types of plants and plant parts including trees shrubs, field crops, potted plants, cut flowers (stems, leaves and flowers) and harvested fruits and vegetables. In an embodiment of the invention, the term “plant” refers to harvested fruit or vegetables. In a further embodiment of the invention, the fruit and vegetables are climacteric. In another embodiment of the invention the fruit and vegetables are those that are prone to spoilage. In a still further embodiment of the invention the fruit is, for example (but not limited to) a stone fruit, such as, for example peaches, cherries, nectarines, apricots and plums, or is apples, pears, melons or berries and the vegetable is, for example, (but not limited to) tomatoes, lettuce, onions, carrots, cabbage, broccoli, beans and cauliflower. In another embodiment of the invention the plant is a fresh cut fruit or vegetable.

The compositions or delivery vehicles of the invention may be placed into a modified atmosphere package containing one or more plants or plant parts. The hygroscopic compound(s) absorbs water from the humidity vapor in the package and this hydrates the yeast mixtures and enzymes, which in turn, metabolize the cyclodextrin-based encapsulation matrix that imobilizes the cyclopropenes as well as any organic substrates in the mixture. Metabolism of the cyclodextrin leads to release of the highly volatile cyclopropenes into the headspace of the package. Action of the yeasts and enzymes on the cyclodextrin and other organic substrates yields alcohols and aldehydes, which are also volatile and diffuse, along with the cyclopropenes, throughout the modified atmosphere package. Both the anti-ethylene effects of cyclopropenes and the bioactive effects of the alcohols and aldehydes lead to improved quality retention of the plants or plant parts and reduction of growth and survival of decay microorganisms during the storage of that package. In addition, the production of alcohol is accompanied by carbon dioxide evolution, which enhances the carbon dioxide levels in the package. Ethanol (EtOH), acetaldehyde (AA) and carbon dioxide are major anaerobic metabolic products produced by plant tissues (Toivonen, P.M.A. (1997) Non-ethylene, non-respiratory volatiles in harvested fruits and vegetables: their occurrence, biological activity and control, Postharvest Biology and Technology 12: 109-125; Beaulieu, J. C., Peiser, C. and Saltveit, M. E. (1997) Acetaldehyde is a causal agent responsible for ethanol-induced ripening inhibition in tomato fruit, Plant Physiology 113: 431-439) and exogenous applications of these products have been documented in controlling fungal decay organism growth, inhibiting ripening in some fruits, and controlling postharvest disorders of some fruits (Beaulieu, J. C. ibid; Lichter, A., Zutkhy, Y., Sonego, L., Dvir, O., Kaplunov, T., Sarig, P. and Ben-Arie, R (2002) Ethanol controls postharvest decay of table grapes, Postharvest Biology and Technology 24: 301-308; Ritenour, M. A., Mangrich, M. E., Beaulieu, J. C., Rab, A. and Saltveit, M. E. (1997) Ethanol effects on the ripening of climacteric fruit, Postharvest Biology and Technology 12: 35-42; Avissar, I., Marinansky, R. and Pesis, E. (1989) Postharvest decay control of grape by acetaldehyde vapors, Acta Horticulturae 258: 655-660; Pesis, E. and Marinansky, R. (1992) Carbon dioxide and ethylene production by harvested grape berries in response to acetaldehyde and ethanol, Journal of the American Society for Horticultural Science 117: 110-113; Ahmadi, H., Biasi, W. V., and Mitcham, E. J. (1999) Control of brown rot decay of nectarines with 15% carbon dioxide atmospheres, Journal of the American Society for Horticultural Science 124: 708-712). High carbon dioxide levels are known to reduce rates of deterioration in plants and to inhibit the growth of many decay microorganisms. Levels of 10-15% carbon dioxide at elevated temperatures have been shown to have a similar effect as storing the product at 1° C. (Sunmer, N. F. ibid).

The term “low temperature(s)” as used herein with respect to the storage and/or handling temperature for the plants means a temperature in the range of about 0° C. to about 2° C.

The term “elevated temperature(s)” as used herein with respect to the storage and/or handling temperature for the plants means a temperature in the range of about 5° C. to about 20° C.

The present invention also includes a commercial package comprising a composition of the present invention, or one or more delivery vehicles comprising a composition of the present invention, enclosed in a modified atmosphere package. To enclose the composition of the present invention, or delivery vehicles comprising a composition of the present invention, in a modified atmosphere environment, the commercial package may be enclosed with a film. The film would be such that carbon dioxide would accumulate to about 5% to about 15%, suitably about 10% to about 15%, inside the package and it would be relatively impermeable to 1-MCP to ensure that its concentration is retained at a biologically significant level (˜1 ppm) for at least 24 hours after sealing of the package.

Selection of the film can be accomplished by determining the respiration (carbon dioxide evolution) rate of the plant at the temperature which it is expected to be held or stored. This value, along with some information on the package format can be entered into the following equation to yield a recommended carbon dioxide transmission rate:

$$C {O}_{2} TR ( mL C {O}_{2} / {m}^{2} / 24 h ) = \frac{\begin{matrix}Respiration Rate ( mL C {O}_{2} / kg / h ) \times \\ 24 h \times Weight of Product ( kg ) \times 10\end{matrix}}{Bag Area ( {m}^{2} )}$$

where, CO₂TR is the specified carbon dioxide transmission rate of the required film, in units of mL CO₂ per m² per 24 h, at the temperature which the plant is to be held or stored; the respiration rate refers to the respiration rate of the plant in question at the temperature which it is to be held or stored; the bag area represents the total surface area of the bag or package in which the plant will be packaged (i.e. area of one side of the bag multiplied by two). Manufacturers of film may not provide CO₂TR values, however if the film is polyethylene or polyolefin, the manufacturers OTR (oxygen transmission rate) can be multiplied by 5 or 6, respectively, to obtain a reasonable estimate of the CO₂TR. Plastic film manufacturers may not provide information on the OTR or CO₂TR at different temperatures and may in fact only provide OTR at the standard temperature of 73° F. (23° C.). In such cases, an estimate of the OTR for a temperature lower than 23° C. can be made as follows: at 15° C. multiply the standard OTR by 0.75, at 10° C. multiply the standard OTR by 0.60, and at 5° C. multiply the standard OTR by 0.44. Interpolations can be made for temperatures between those discussed herein. In an embodiment of the invention, the film comprises polyethylene or polyolefin.

The present invention further relates to a method of inhibiting an ethylene response in a plant comprising effecting the release of cyclopropene, alcohols, aldehydes and/or carbon dioxide from the compositions of the invention in the presence of the plant.

The present invention also provides a method of slowing ripening, inhibiting postharvest decay, slowing softening and/or inhibiting discolouration in plants comprising effecting the release of cyclopropene, alcohols, aldehdyes and/or carbon dioxide from the compositions of the invention in the presence of the plants. The plants may be stored at low or elevated temperatures.

In an embodiment of the present invention, the methods are applied in modified atmosphere packaged fruits and vegetables and fresh-cut fruit and vegetable products. The scale of this application can range from a package containing as little as 50 g, and smaller, of produce up to the size of a tote bin containing 450 kg, and larger, of produce. Under these conditions, temperature control may not be very reliable, and thus the methods of the present invention are also effective at elevated handling temperatures.

The following non-limiting examples are illustrative of the present invention:

### EXAMPLES

### Example 1

### Relative Shelf Stability

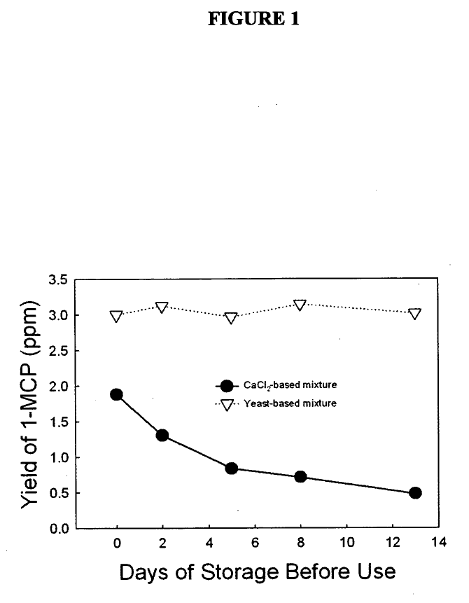

Technology developed at Michigan State University for improving the storage quality of packaged plants is based on the use of hygroscopic salts such as CaCl₂ in the presence of cyclodextrin immobilized 1-MCP. 1-MCP liquefies and the resultant liquid interacts with the immobilizing cyclodextrin matrix to effect release of 1-MCP (Sittipod, S. ibid). A test was conducted to compare the shelf stability of the technology proposed by Michigan State University and the co-release technology of the present invention. The test involved the formulation of each technology and production of five units of each formulation. On the day of production, one unit of each technology was enclosed in a humidified container and the release of 1-MCP was monitored using gas chromatography. This was repeated four more times, on days 2, 5, 8, and 13, after the sachets were made. The sachets were stored in sealed plastic bags until they were used. It can be seen in FIG. 1 that the co-release technology of the present invention resulted in 50% more 1-MCP release than the Michigan CaCl₂-based technology on the first day, even though both formulations contained the same amount of cyclodextrin-immobilized 1-MCP. The yield of 1-MCP from the co-release formulation of the present invention remained the same as on first day, up to thirteen days of storage before use. In contrast, the yield from the CaCl₂-based technology dropped to 25% of the original yield with that technology. These results indicate that the previously reported technology is not shelf stable and may therefore have limited commercial use, whereas the co-release technology of the present invention is both shelf stable and significantly more efficient at 1-MCP release. Shelf stability is an important characteristic for commercial viability of a product.

### Example 2

### Comparison of Co-Release Formulations for 1-MCP, Ethanol, and Acetaldehyde

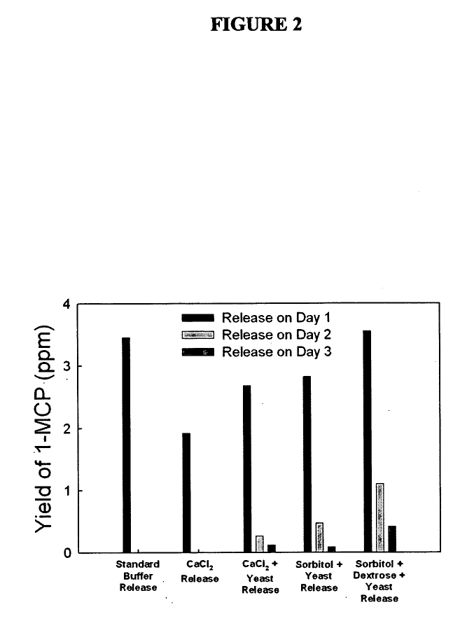

Tests were conducted to evaluate a variety of co-release formulations, in particular with respect to their ability to release 1-MCP, produce ethanol and acetaldehyde and the duration of the release of these substances. The control for this was a standard release of 1-MCP from cyclodextrin using a buffer solution. The Michigan State University formulation (CaCl₂ and 1-MCP immobilized in cyclodextrin) was used as a second control. A yeast mixture was added to the Michigan CaCl₂-based formulation as the first possible 9 co-release technology under consideration. A second co-release mixture was formulated using sorbitol as a hygroscopic agent in lieu of CaCl₂, with a yeast mixture and the cyclodextrin-immobilized 1-MCP. A third co-release mixture was formulated using sorbitol, dextrose, and a mixture of yeasts plus the cyclodextrin-immobilized 1-MCP. FIG. 2 shows that the standard buffer release produces as much 1-MCP yield as any other mixture, however, no further release is found after day one. The CaCl₂-based release results in the lowest yield of 1-MCP and there is no release after day one. However, when yeast is added to the CaCl₂, the yield is improved on day one, and there is a minor additional release of 1-MCP on days two and three. Similar results are found with the sorbitol-based release formulation. The highest yield (same as the standard buffer release) is found for the co-release formulation containing sorbitol, dextrose, and a yeast mixture. In addition, there is a significant residual release of 1-MCP on the second and third days. These results indicate that the co-release formulation of the present invention is as efficient as the standard buffer release system and has an added feature of providing residual release over at least three days. Extended exposure to 1-MCP will be advantageous. There are reports indicating that extended exposure to 1-MCP can lead to significantly improved quality retention (Blankenship, S. M. ibid; Mattheis, J. ibid; Canoles, M. A. ibid).

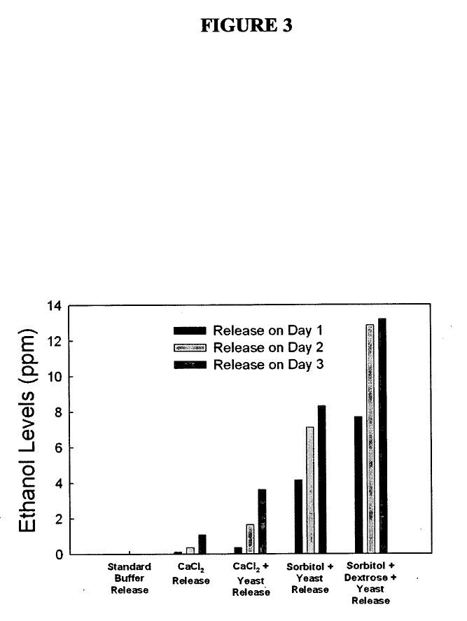

The co-release mixtures were also tested for their ability to generate gaseous ethanol and acetaldehyde (FIGS. 3 & 4). Ethanol and acetaldehyde release increased in the following order: standard buffer <CaCl₂<CaCl₂+yeast<sorbitol+yeast<sorbitol+dextrose+yeast. Significant levels of ethanol and acetaldehyde were only produced with the sorbitol+yeast and the sorbitol+dextrose+yeast formulations. It can be concluded that the amount of ethanol and acetaldehyde produced can be determined by the amount of sugar (dextrose) that is placed in the mixture. As stated above for 1-MCP release, the optimal formulation in terms of ethanol and acetaldehyde was the co-release technology described in the present invention which comprises sorbitol, dextrose, yeast, and cyclodextrin-immobilized 1-MCP.

While the current testing has been conducted with systems producing ethanol and acetaldehyde, the technology may also include yeasts and/or enzyme mixtures that would produce higher alcohols and/or aldehydes from various carbohydrate substrates. Of particular interest would be hexanol and hexanal (six carbon alcohol and aldehyde, respectively). Higher alcohols and aldehydes have been shown to be inhibitory to decay organisms, while less bioactive in regards to fruit and vegetable tissues ². In situations, where effects of ethanol and/or acetaldehyde may be damaging to the fruit and vegetable tissues, the use of systems with higher alcohols and aldehydes may be preferred.

### Example 3

### Efficacy of Co-release Technology

(a) Stone Fruit

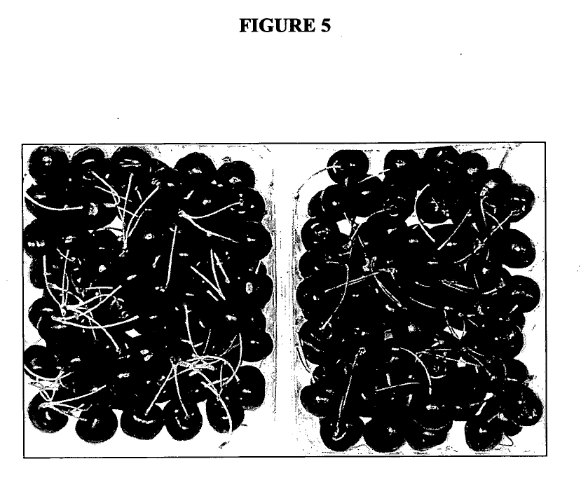

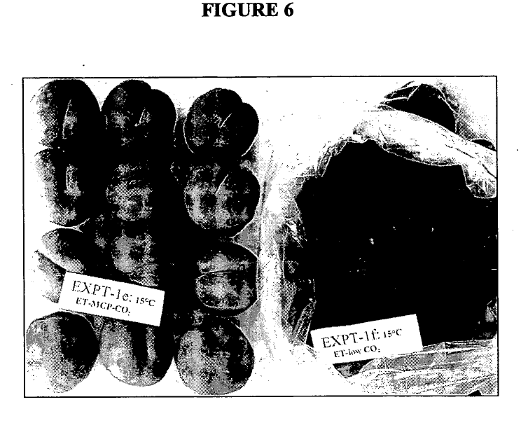

Testing has shown the formulations of the present invention to be ideal for maintaining the quality of stone fruits. The composition of the formulation in this example was 6% bakers yeast (Type II), 7% inactivated yeast, 71% sorbitol, 7% dextrose and 9% 1-MCP encapsulated in cyclodextrin. Sweet cherries have been shown to maintain fresh-like quality over three weeks using the technology (FIG. 5). Peaches, nectarines, and apricots have all maintained just-picked quality after three to four weeks of storage at 15-20° C. when using the co-release technology of the present invention. An example of typical results obtained using the co-release technology is shown for apricots in FIG. 6. The formulations of the present invention will be useful particularly in mixtures containing fruits such as melons, apples, pears, other climacteric-type fruits, as well as vegetables such as tomatoes, lettuce, onions, carrots, cabbage, broccoli and cauliflower.

(b) Sliced Tomatoes

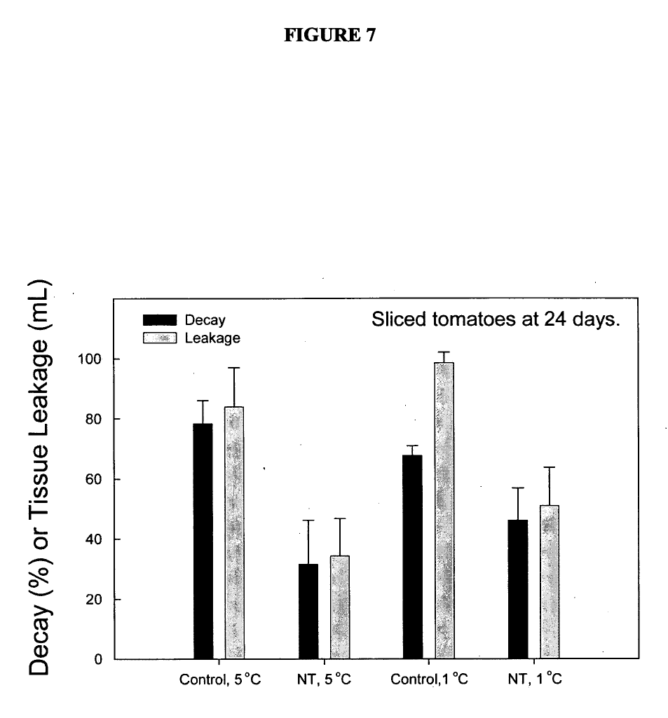

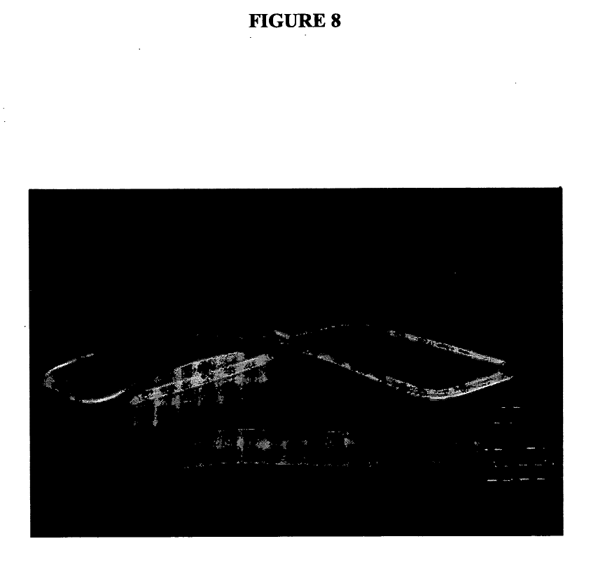

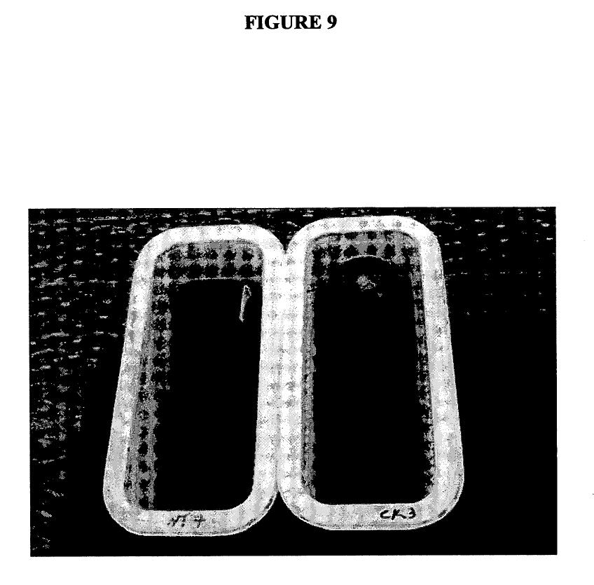

Sliced tomatoes were obtained from a local fresh-cut processor in the existing packaging which provides for high carbon dioxide atmospheres. Prior to sealing, six of the trays had sachets containing the composition of the present invention placed at the top of the sliced tomatoes (labeled as NT for “new technology), whereas the other six trays contained only sliced tomatoes without the sachets of the composition of the present invention. The composition of the formulation in this example was 2.5% bakers yeast (Type I), 7.6% bakers yeast (Type II), 7.6% inactivated yeast, 63.3% sorbitol, 12.7% dextrose and 6.3% 1 -MCP encapsulated in cyclodextrin. Three of the trays containing the sachets of the composition of the present invention and three of the trays without the sachets of the composition of the present invention were placed into 5° C. storage for 24 days while three of the trays containing the sachets of the composition of the present invention and three of the trays without the sachets of the composition of the present invention were placed into 1° C. storage for 24 days. The results are shown in FIG. 7. Trays containing the sachets of the composition of the present invention had half of the incidence of decaying sliced tomatoes than those without the sachets of the composition of the present invention. In addition, leakage from the tomato slices into the trays was also found to be reduced by half when the sachets of the composition of the present invention were placed into the trays. FIGS. 8 and 9 show that the composition of the present invention prevents the development of bulging in the sealed tray at 24 days whereas the control tray has liquid bathing the tomatoes slices, the liquid being leaked out from the deteriorating tomato slices. The deterioration of the slices in the control tray is attributed to yeast and bacterial growth on the slices that caused them to break down and become structurally weak and translucent in appearance.

(c) Tossed Salad Mix

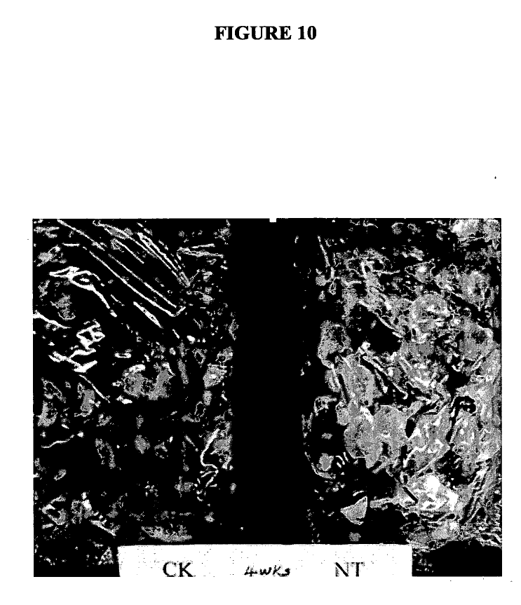

The packaged fresh-cut tossed salad mixes were identified as being problematic by a local processor and these were selected for testing with the composition of the present invention. The composition of the formulation in this example was 2.1% bakers yeast (Type I), 6.5% bakers yeast (Type II), 10.8% inactivated yeast, 64.5% sorbitol, 10.8% dextrose and 5.3% 1-MCP encapsulated in cyclodextrin. The “Tossed Salad” mix contained cut iceberg lettuce, sliced red onions, whole grape tomatoes, shredded carrots and sliced red cabbage. The vegetables were produced and mixed at the fresh-cut processor's facility and packaged at the research centre. The packaging was selected to produce a high carbon dioxide atmosphere. Six of the packages had sachets containing the composition of the present invention placed into the bags, whereas the other six packages contained only the vegetables without the sachets of the composition of the present invention. All of the bags were then sealed and stored at 5° C. for 28 days. FIG. 10 shows the differences in quality between the controlled packages and those having the sachets of the composition of the present invention included in the packages. The vegetables in the controlled packages were almost totally broken down, and browning as well as other discoloration was prevalent on over 80% of the cut vegetables. The grape tomatoes had also turned soft. In contrast, the packages containing sachets of the composition of the present invention looked to be in excellent and fresh condition with little browning (minor severity on less than 20% of product). No breakdown of the vegetables was observed.

(d) Vegetable Medley Salad Mix

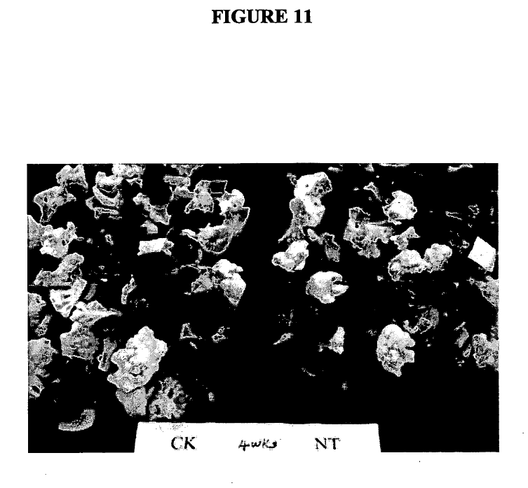

Another packaged fresh-cut salad mix which was identified to be problematic by a local processor was a “Vegetable Medley” mix which is generally used for stir fry. The composition of the formulation in this example was 4.2% bakers yeast (Type I), 6.3% bakers yeast (Type II), 10.4% inactivated yeast, 62.5% sorbitol, 10.4% dextrose and 6.2% 1-MCP encapsulated in cyclodextrin. The “Vegetable Medley” mix contained broccoli, cauliflower, sliced red onions and sliced carrots. Similar to the “Tossed Salad” mix, the vegetables of the “Vegetable Medley” mix were produced and mixed at the fresh-cut processor's facility and packaged at the research centre. Six of the packages had sachets containing the composition of the present invention placed into the bags, whereas the other six packages contained only the vegetables without the sachets of the composition of the present invention. All of the bags were then sealed and stored at 5° C. for 28 days. FIG. 11 shows the differences in- quality between the controlled packages and those having the sachets of the composition of the present invention included in the packages. The broccoli in the controlled packages became loose and yellow; the cauliflower became brown and ricy (loose and brittle); the carrots developed whitening on the cut surface; and the onions became soft and translucent (Table 1). In the packages containing sachets of the composition of the present invention, the broccoli remained firm and bright; the cauliflower was firm (not ricy), the carrots maintained a bright orange appearance; and the onions were opaque and firm (Table 1). This test shows that the composition of the present invention is particularly effective for the “Vegetable Medley” mix, particularly in maintaining the fresh-like quality of the carrot and cauliflower components.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1
The quality of the components of a “Vegetable Medley” stir
fry mix after 28 days of storage at 5° C. in control packages
or in packages having the compositions of the present invention.

Percent Acceptable

| Component Vegetable | Control | Present Invention |
|---|---|---|
| Sliced Carrot | 22.4 | 75.6 |
| Cauliflower Florets | 22.9 | 59.2 |
| Broccoli Florets | 84.7 | 88.7 |
| Cut Onions | 23.3 | 34.1 |

Note:
Indications of loss of acceptability:
for carrots - whitening;
for cauliflower - browning of cut edges and riciness;
for broccoli - loosening and yellowing; and
for cut onions - development of translucent appearance and softening.

What is claimed is:

1. A composition comprising:
(a) one or more cyclopropenes of the formula I: 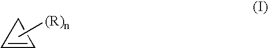
wherein
n is a number from 1 to 4,
R is selected from the group consisting of hydrogen, saturated or unsaturated C₁ to C₄ alkyl, hydroxy, halogen, saturated or unsaturated C₁ to C₄ alkoxy and amino,
n and R are selected to provide a volatile compound of formula I,
and the compound of formula I is encapsulated in a cyclodextrin-based encapsulating agent;
(b) one or more hygroscopic compounds; and
(c) yeast and/or one or more enzymes involved in the production of alcohols and aldehydes from organic substrates.

2. The composition according to claim 1, further comprising one or more organic substrates which are acted upon by the yeast and/or the one or more enzymes, to produce alcohols and aldehydes.

3. The compositions according to claim 1, wherein n is 1 or 2.

4. The composition according to claim 3, wherein n is 1.

5. The composition according to claim 1, wherein R is saturated or unsaturated C₁ to C₄ alky.

6. The composition according to claim 5, wherein R is a straight-chain, saturated C₁ to C₄ alkyl.

7. The composition according to claim 5, wherein R is methyl, ethyl, n-propyl, isopropyl, t-butyl, isobutyl, n-butyl, vinyl, 2-propenyl, or 3-butylenyl.

8. The composition according to claim 7, wherein R is methyl.

9. The composition according to claim 1 having the formula I(a):

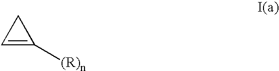

10. The composition according to claim 1, wherein the cyclopropene is 1-methylcyclopropene (1-MCP).

11. The composition according to claim 1, wherein the encapsulating agent is selected from α-cyclodextrin, β-cyclodextrin and γ-cyclodextrin.

12. The composition according to claim 11, wherein the encapsulating agent is α-cyclodextrin.

13. The composition according to claim 1, wherein the one or more hygroscopic compounds is a Generally Regarded As Safe (GRAS) hygroscopic or water-absorbing compound selected from super absorbent polymers, inorganic deliquescent compounds and hygroscopic organic compounds and any combinations and mixtures thereof.

14. The composition according to claim 13, wherein the super absorbent polymer is selected from sodium polyacrylate (crosslinked), acrylamide/acrylate copolymer and carboxymethylcellulose.

15. The composition according to claim 13, wherein the inorganic deliquescent compound is selected from calcium chloride, magnesium chloride, lithium chloride, zinc chloride, magnesium nitrate and aluminum nitrate.

16. The composition according to claim 13, wherein the one or more hygroscopic compounds is selected from calcium chloride and sorbitol.

17. The composition according to claim 16, wherein the hygroscopic compound is sorbitol.

18. The composition according to claim 1, wherein the one or more enzymes involved in the production of alcohols and aldehydes from organic substrates is selected from amylose, cellulase, phytase, hemi-cellulase, maltase, invertase, beta-glucanase and apha-glucosidase.

19. The composition according to claim 2, wherein the one or more organic substrates which are acted upon by the yeast and/or the one or more enzymes, to produce alcohols and aldehydes, is selected from allose, altrose, glucose, mannose, gulose, idose, galactose, talose, ribose, arabinose, xylose, lyxose, threose, erythrose, glyceraldehydes, sorbose, fructose, dextrose, levulose, sorbitol, sucrose, maltose, cellobiose, lactose, and combinations and mixtures thereof.

20. The composition according to claim 19, wherein the organic substrate is sorbitol.

21. The composition according to claim 1, further comprising one or more adjuvants.

22. The composition according to claim 21, wherein the one or more adjuvants is selected from extenders, binders, lubricants, surfactants and/or dispersants, wetting agents, spreading agents, dispersing agents, stickers, adhesives, defoamers, thickeners and emulsifying agents.

23. The composition according to claim 1, wherein the one or more cyclopropenes of the formula I are present in an amount of from about 1% to about 25%.

24. The composition according to claim 23, wherein the one or more cyclopropenes of the formula I are present in an amount of from about 2% to about 20%.

25. The composition according to claim 1, wherein the one of more hygroscopic compounds are present in an amount of from about 40% to about 80%.

26. The composition according to claim 25, Wherein the one of more hygroscopic compounds are present in an amount of from about 50% to about 75%.

27. The composition according to claim 1, wherein the yeast and/or one or more enzymes involved in the production of alcohols and aldehydes from organic substrates are present in an amount of from about 5% to about 25%.

28. The composition according to claim 27, wherein the yeast and/or one or more enzymes involved in the production of alcohols and aldehydes from organic substrates are present in an amount of from about 10% to about 20%.

29. The composition according to claim 2, wherein the one or more organic substrates which are acted upon by yeast and/or the one or more enzymes to produce alcohols and aldehydes are present in an amount of from about 0% to about 35%.

30. The composition according to claim 29, wherein the one or more organic substrates which are acted upon by yeast and/or the one or more enzymes to produce alcohols and aldehydes are present in an amount of from about 5% to about 30%.

31. The composition according to claim 21, wherein the one or more adjuvants are present in an amount of from about 0% to about 15%.

32. The composition according to claim 31, wherein the one or more adjuvants are present in an amount of from about 5% to about 10%.

33. The composition according to claim 2 comprising:
a) about 2% to about 20% 1-MCP encapsulated in cyclodextrin;
b) about 10% to about 20% dried yeast;
c) about 50% to about 75% sorbitol;
d) about 5% to about 30% dextrose; and optionally
e) about 0% to about 10% one or more adjuvants.

34. A delivery vehicle comprising a composition according to claim 1.

35. The delivery vehicle according to claim 34 which is selected from sachets, tablets and absorbent pads.

36. A commercial package comprising a composition according to claim 1, or one or more delivery vehicles according to claim 34, enclosed in a modified atmosphere package.

37. A method of inhibiting an ethylene response in a plant comprising effecting the release of the cyclopropene, alcohols, aldehydes and/or carbon dioxide from the composition according to claim 1 in the presence of the plant.

38. A method of slowing ripening, inhibiting postharvest decay, slowing softening and/or inhibiting discolouration in plants comprising effecting the release of the cyclopropene, alcohols, aldehdyes and/or carbon dioxide from the compositions according to claim 1 in the presence of the plant.

39. The method according to claim 37, wherein the plant is selected from trees shrubs, field crops, potted plants, cut flowers and harvested fruits and vegetables.

40. The method according to claim 39, wherein the cut flowers comprise stems, leaves or flowers.

41. The method according to claim 39, wherein the plant is selected from harvested fruit, harvested vegetables, fresh cut fruits, fresh cut vegetables and mixtures thereof.

42. The method according to claim 41, wherein the fruit and vegetables are climacteric.

43. The method according to claim 41, wherein the fruit and vegetables are those that are prone to spoilage.

44. The method according to claim 41, wherein the fruit is selected from stone fruit, apples, pears, melons and berries.

45. The method according to claim 44, wherein the stone fruit is selected from peaches, cherries, nectarines, apricots and plums.

46. The method according to claim 41 wherein the vegetable is selected from tomatoes, lettuce, onions, carrots, cabbage, broccoli, beans and cauliflower.

47. The method according to claim 39, wherein the plant is selected from fresh cut fruit, fresh cut vegetables and mixtures thereof.
